(19) United States
(12) Patent Application Publication
(10) Pub. No.: US 2006/0166077 A1
(43) Pub. Date: Jul. 27, 2006

(54) Thin membrane electrode assembly for fuel cell and fuel cell including the same

(75) Inventors: Seung-jae Lee, Seongnam-si (KR); Ji-rae Kim, Seoul (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/328,202

(22) Filed: Jan. 10, 2006

(30) Foreign Application Priority Data
Jan. 26, 2005 (KR) 2005-7237

(51) Int. Cl. H01M 4/94; H01M 4/88

(52) U.S. Cl. 429/44; 502/101

(57) ABSTRACT

A thin membrane electrode assembly for a fuel cell includes a diffusion layer with openings and thus does not require a separate carbon substrate. The membrane electrode assembly can be used to manufacture a slim, compact fuel cell. The membrane electrode assembly also ensures a quick response and stable electric generation and lowers electrical resistance, thereby enabling a high performance fuel cell to be manufactured. In addition, since no separate carbon substrate is required, the manufacturing costs of the membrane electrode assembly are reduced.

### CROSS-REFERENCE TO RELATED APPLICATION

This application claims the benefit of Korean Patent Application No. 2005-7237, filed on Jan. 26, 2005, in the Korean Intellectual Property Office, the disclosure of which is incorporated herein in its entirety by reference.

### BACKGROUND OF THE INVENTION

1. Field of the Invention

An aspect of the present invention relates to a thin membrane electrode assembly (MEA) for fuel cells and a fuel cell including the same, and more particularly, to an MEA that has small thickness and low mass transfer resistance so that electric power can be stably generated and low electrical resistance can be obtained, and a fuel cell including the same.

2. Description of the Related Art

Fuel cells are power generating systems which directly convert the chemical reaction energy of hydrogen and oxygen contained in hydrocarbons, such as methanol, ethanol, or natural gas, into electric energy.

In a fuel cell system, a stack substantially generating electricity is formed by depositing a few to tens of unit cells, each cell including an MEA and a separator (or a bipolar plate). The MEA has a structure including an anode (also referred to as fuel electrode or oxidation electrode) and a cathode (also referred to as air electrode or reduction electrode) bound with each other with a polymer electrolyte membrane therebetween.

A conventional MEA will be described in detail with reference FIG. 1.

Referring to FIG. 1, an electrolyte membrane 50 is interposed between a cathode 20 and an anode 10. The anode 10 and the cathode 20 respectively include catalyst layers 16 and 26, diffusion layers 14 and 24, and carbon substrates 12 and 22.

The catalyst layers 16 and 26, in which oxidation and reduction reactions take place, are manufactured using supported catalysts. The diffusion layers 14 and 24 respectively support the anode 10 and the cathode 20 and distribute reactants into the catalyst layers 16 and 26, allowing the reactants to easily access the catalyst layers 16 and 26. The carbon substrates 12 and 22 are made of carbon cloth, carbon paper, and the like. In general, the carbon substrate 12 of the anode 10 does not include a binder, while the carbon substrate 22 of the cathode 20 includes a binder.

The electrolyte membrane 50 transports protons generated in the anode 10 to the cathode 20, has an insulating function for preventing electrons generated in the cathode 20 from moving to the anode 10, and acts as a barrier layer preventing unreacted hydrogen from moving to the cathode 20 and unreacted oxidant from moving to the anode 10.

In general, the electrolyte membrane 50 has a thickness of about 100 μm, each of the catalyst layers 16 and 26 has a thickness of about 20 μm, each of the diffusion layers 14 and 24 has a thickness of about 40 μm, and each of the carbon substrates 12 and 22 has a thickness of about 100 to 300 μm. Therefore, the thicknesses of the carbon substrates 12 and 22 are about 50-70% of the thickness of the MEA.

Such a high proportion of the carbon substrates 12 and 22 in the thickness of the conventional MEA hinders the manufacturing of slim, compact fuel cells.

Typically, a carbon substrate (1) uniformly diffuses reactants, such as fuel, water, air, and the like, (2) collects the generated electricity, and (3) protects materials of the catalyst layers and the diffusion layers from being swept away by fluid.

When the flow of an oxidant in the cathode is not sufficient, it is difficult to remove water generated in the cathode and thus the water fills the micropores of the carbon substrate, which is referred to as flooding. This flooding is a significant obstacle to be solved in fuel cells. In order to remove water and prevent such flooding, a water-repellent binder is added into the carbon substrate. However, in this case, the current collecting property deteriorates. In addition, since materials in the carbon substrate are not uniformly distributed, the length of a mass transfer path increases and local flooding occurs, which directly cause unstable mass transfer and slow response.

Conventionally, MEAs have been manufactured as below (See FIG. 2A).

First, catalyst layers are respectively formed on films, the films with the catalyst layers are attached to both sides of an electrolyte membrane, and then the films are removed. Each of the catalyst layers contains an appropriate active component according to whether the catalyst layer is used as a cathode or an anode.

Then, diffusion layers containing binders are respectively formed on carbon substrates. The carbon substrates with the diffusion layers are coupled to the electrolyte membrane-catalyst layer assembly manufactured above, such that the diffusion layers face the catalyst layers of the electrolyte membrane-catalyst layer assembly. As a result, the carbon substrates form the outermost surfaces of the assembly. Through the above-described processes, conventional MEAs have been manufactured.

As described above, the electrolyte membrane of a conventional MEA undergoes two bonding processes and thus deteriorates due to dehydration by heat during the bonding processes.

Therefore, there is room for improvements in connection with the thickness of an MEA, the stability of reactant supply, which is directly related with the stability of electricity generation, and the lifespan of the electrolyte membrane.

### SUMMARY OF THE INVENTION

An aspect of the present invention provides a membrane electrode assembly (MEA) that is thin and can stably produce electricity due to low mass transfer resistance and can efficiently operate due to low electrical resistance.

Another aspect of the present invention provides a method of manufacturing the MEA.

Another aspect of the present invention provides a fuel cell including the MEA.

According to an aspect of the present invention, there is provided a membrane electrode assembly including: a cathode including a catalyst layer and a diffusion layer having openings; an anode including a catalyst layer and a diffusion layer having openings; and an electrolyte membrane interposed between the cathode and the anode.

According to another aspect of the present invention, there is provided a method of manufacturing a membrane electrode assembly, the method including: respectively forming catalyst layers on films and drying the catalyst layers to form catalyst layer units; respectively forming diffusion layers on films and sintering the diffusion layers to form diffusion layer units; forming openings in each of the formed diffusion layer units; respectively bonding the catalyst layer units and the diffusion layer units such that the catalyst layer on each of the catalyst layer units contacts the diffusion layer of the corresponding diffusion layer unit to form electrode units; bonding the electrode units to both sides of a polymer electrolyte membrane; removing the film from each of the catalyst layer units after any one of the above operations; and removing the film from each of the diffusion layer units after any one of the above operations.

According to yet another aspect of the present invention, there is provided a fuel cell including the membrane electrode assembly.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a sectional exploded view of a conventional membrane electrode assembly (MEA);

FIG. 2A is a flowchart of a method of manufacturing a conventional MEA;

FIG. 2B is a flowchart of a method of manufacturing an MEA according to an embodiment of the present invention;

FIG. 3A is a photograph of a catalyst layer unit manufactured in Example 1 according to an embodiment of the present invention; and

FIG. 3B is a photograph of a patterned diffusion layer unit manufactured in Example 1 according to an embodiment of the present invention;

FIG. 4 is a photograph of a MEA manufactured in Example 1 according to an embodiment of the present invention;

FIG. 5 is a graph of performance of the unit cells manufactured in Example 1 according to an embodiment of the present invention and Comparative Example 1; and

FIG. 6 is a graph of the results of an electricity generation stability test on the unit cells manufactured in Example 1 according to an embodiment of the present invention and Comparative Example 1.

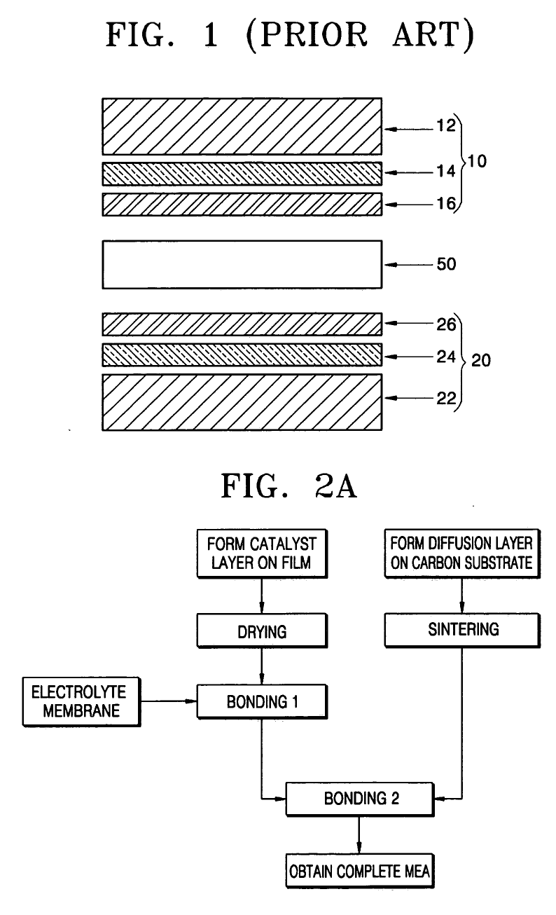

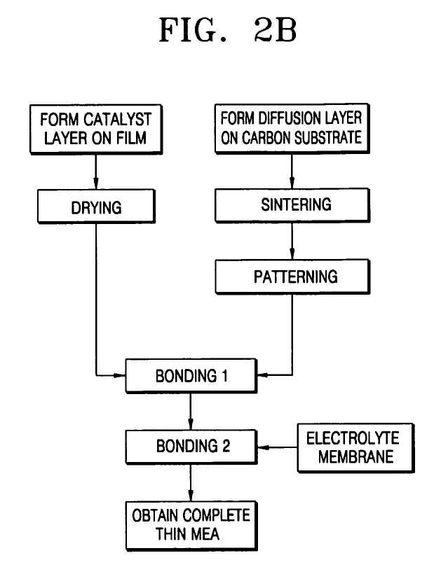

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

A membrane electrode assembly (MEA) according to an aspect of the present invention includes: a cathode including a catalyst layer and a diffusion layer with openings; an anode including a catalyst layer and a diffusion layer with openings; and an electrolyte membrane interposed between the cathode and the anode.

The catalyst layer and the diffusion layer may be conventional ones known to those skilled in the art. However, unlike conventional diffusion layers, the diffusion layer according to an aspect of the present invention has openings.

The shapes of the openings have no limitation; it may be, but is not limited to, circular, polygonal such as rectangular, triangular, etc., or bands.

However, in consideration of the mechanical strength, deformability, and easy processing of a patterned diffusion layer unit, the aspect ratio of the openings may be in the range of 1 to 3. If the aspect ratio does not lie in the above range, processing becomes difficult, the diffusion layer unit is more likely to deform, the mechanical strength reduces, and the diffusion layer unit is more likely to be broken during the processing.

The total area of the openings may be 5 to 85%, preferably 30 to 65%, of the area of the diffusion layer unit. If the total area of the openings is less than 5% of the area of the diffusion layer unit, mass transfer is inefficient and thus the formation of the openings is meaningless. If the total area of the openings is greater than 85%, the mechanical strength decreases and thus processing becomes difficult.

The anode may include a hydration layer. The hydration layer is formed on a surface of the diffusion layer of the anode facing away from the catalyst layer. The hydration layer facilitates hydration of the electrolyte membrane, and may be composed of, for example, SiO₂, TiO₂, phosphotungstic acid, phosphomolybdenum acid, or the like. However, any hydrating material, not limited to the above-listed materials, can be used to form the hydration layer.

The thickness of the hydration layer may be in the range of 0.01 to 1 μm. The hydration layer is an electrically non-conductive layer. Therefore, if such an electrically non-conductive hydration layer fully covers the surface of the diffusion layer, the generated electric current cannot be collected. Accordingly, the hydration layer may be formed as a sea-island type.

A method of manufacturing the MEA according to an aspect of the present invention will be described in detail below.

Manufacturing of Catalyst Layer Unit

A catalyst layer unit is manufactured by forming a catalyst layer on a film and drying the catalyst layer. The film may be, but is not limited to, a Teflon film, a PET film, a captone film, a Tedra film, an aluminum foil, or a mylar film. Any film that allows a catalyst layer formed thereon to be transferred can be used.

The catalyst layer can be formed using any method used to form a catalyst layer with uniform thickness on a film. Examples of the method of forming the catalyst layer include, but are not limited to, a tape casting method, a spraying method, a screen printing method, etc., which are used to coat a catalyst slurry on the film.

The catalyst slurry may be a diffusion of a carrier-supported catalyst in liquid, or a liquid diffusion of a matrix containing dispersed catalyst particles. In addition, according to whether a catalyst layer unit to be manufactured is used for an anode unit or cathode unit, the components and composition of a catalyst to be used is determined.

The liquid acts as a diffusion medium. Preferred examples of the diffusion medium include, but are not limited to, water, ethanol, methanol, isopropylalcohol, n-propylalcohol, butylalcohol, or the like, with the water, methanol, and isopropylalcohol being more preferred.

The catalyst slurry may include a conductive material, for example, Nafion.

When preparing a catalyst slurry, the carrier-supported catalyst, the diffusion medium, and the conductive material may be mixed in a ratio of 1:3:0.15, but not limited thereto. The catalyst slurry may be prepared by mixing a mixture of the components in an appropriate ratio in a sonic bath for 1 to 3 hours.

The catalyst layer formed through the above processes is dried at a temperature of 60-120° C. for 1 to 4 hours to remove the used diffusion medium. If the drying temperature is lower than 60° C., the diffusion medium is not sufficiently removed and thus the catalyst layer is not completely dried. If the drying temperature is higher than 120° C., the catalyst may be damaged. If the drying time is less than 1 hour, the diffusion medium is not sufficiently removed and thus the catalyst layer is not completely dried. If the drying time is longer than 4 hours, it is uneconomical.

A complete catalyst layer unit is obtained through the drying process. The mass per unit area of the catalyst layer unit may be 2-8 mg/cm². If the mass per unit area of the catalyst layer unit is smaller than 2 mg/cm², the mechanical strength of the catalyst layer weakens. If the mass per unit area of the catalyst layer unit is greater than 8 mg/cm², the catalyst layer may cause resistance against the diffusion of reactants and thus disturb mass transfer.

Manufacturing of Diffusion Layer Unit

Next, in the similar manner for the catalyst layer unit, a diffusion layer unit is manufactured by forming a diffusion layer on a film and sintering the diffusion layer. As described in the manufacturing of the catalyst layer unit, the film may be, but is not limited to, a Teflon film, a PET film, a captone film, a Tedra film, an aluminum foil, or a mylar film. Any film that allows a diffusion layer formed thereon to be transferred can be used.

The diffusion layer can be formed using any method used to form a diffusion layer with uniform thickness on a film. Examples of the method of forming the diffusion layer include, but are not limited to, a tape casting method, a spraying method, a screen printing method, etc., which are used to coat a carbon slurry on the film.

The carbon slurry may be a mixture of carbon powder, a binder, and a diffusion medium. The carbon powder may be any carbon material in powder form, such as powdered carbon black, acetylene black, carbon nanotube, carbon nanowire, carbon nanohorn, carbon nanofiber, etc.

The binder may be, but is not limited to, polytetrafluoroethylene (PTFE), polyvinylidenefluoride (PVdF), fluorinated ethylene propylene (FEP), and the like.

In addition, preferred examples of the diffusion medium include, but are not limited to, water, ethanol, methanol, isopropylalcohol, n-propylalcohol, butylalcohol, etc., with the water, ethanol, methanol, and isopropylalcohol being more preferred.

The preferable composition ratio of the carbon powder, binder, and diffusion medium may be in a range of 0.9:0.1:10 to 0.5:0.5:10, but not limited thereto. The carbon slurry may be prepared by mixing a mixture of the components in an appropriate ratio in a sonic bath for 30 minutes to 2 hours.

The diffusion layer formed through the above processes is sintered at a temperature of 150-350° C. for 30 minutes to 2 hours to remove the used diffusion medium. The sintering of the diffusion layer is performed to remove the used diffusion medium and to appropriately distribute the binder to obtain proper water repellency and prevent loss of the carbon component. If the sintering temperature is less than 150° C., the binder is not sufficiently distributed and cannot properly function, thereby resulting in poor water repellency. If the sintering temperature is higher than 350°, the diffusion layer unit may deform due to excessive heat. If the sintering time is shorter than 30 minutes, the binder is not sufficiently distributed and cannot properly function, thereby resulting in poor water repellency. If the sintering time is longer than 2 hours, it is uneconomical, and the binder is too uniformly distributed and a problem in electric conductivity arises.

The sintering temperature may be adjusted according to the type of the binder. It is preferable that the sintering temperature is adjusted to around the melting point of the binder.

The mass per unit area of the diffusion layer unit completed through the sintering process may be in a range of 0.1-4 mg/cm². If the mass per unit area of the diffusion layer unit is smaller than 0.1 mg/cm², smooth diffusion of fuel cannot be obtained, and the mechanical strength decreases. If the mass per unit area of the diffusion layer unit is greater than 4 mg/cm², the diffusion layer unit may cause resistance against the diffusion of reactants and thus disturb mass transfer.

The sintered diffusion layer unit further undergoes a patterning process. The patterning process refers to a process of forming openings in the diffusion layer unit completed through the above-described processes. The openings may have a circular shape, a polygonal shape, like a rectangle, triangle, etc., or a linear shape, but the shapes of the openings are not limited thereto.

However, in consideration of the mechanical strength, deformability, easy processing of the patterned diffusion layer unit, the aspect ratio of the openings may be in a range of 1-3. If the aspect ratio does not lie in the above range, processing becomes difficult, the diffusion layer unit is more likely to deform, the mechanical strength is reduced, and the diffusion layer unit is more likely to be broken during the processing.

The total area of the openings may be 5 to 85%, preferably 30 to 65%, of the area of the diffusion layer unit. If the total area of the openings is less than 5% of the area of the diffusion layer unit, mass transfer is inefficient and thus the formation of the openings is meaningless. If the total area of the openings is greater than 85%, the mechanical strength decreases and thus processing becomes difficult.

The patterning can be performed by various methods known to those skilled in the art. For example, a method using a cutting plotter can be used. After fixing the sintered diffusion layer unit to a cutting plotter and a desired pattern of openings is designed using a computer aid design (CAD) program, openings are formed in the diffusion layer unit using the cutting plotter. However, the patterning can be performed by various methods, not only by the above-described method using a cutting plotter, known to those skilled in the art.

A diffusion layer unit is completed through the above-described processes.

Manufacturing a Hydration Layer

A process of forming a hydration layer between the film and the diffusion layer may be further included. The hydration layer is formed on a surface of the diffusion layer of the anode facing away from the catalyst layer.

For example, the hydration layer may be formed on the film before the diffusion layer is formed. However, the hydration layer can be formed between the film and the diffusion layer using various methods.

The hydration layer may be composed of, for example, SiO₂, TiO₂, phosphotungstic acid, phosphomolybdenum acid, or the like. However, any hydrating material, not limited to the above-listed materials, can be used to form the hydration layer.

The thickness of the hydration layer may be in a range of 0.01-1 μm. The hydration layer is an electrically non-conductive layer. Therefore, if such an electrically non-conductive hydration layer fully covers the surface of the diffusion layer, the generated electric current cannot be collected. Accordingly, the hydration layer may be formed as a sea-island type.

The hydration layer may be formed using various methods known in the field. However, a spray coating method for forming a localized hydration layer or a method of transferring the film on which the hydration layer has been formed is preferred.

Bonding of Catalyst Layer and Diffusion Layer

Next, an electrode unit is manufactured by coupling the catalyst layer unit and the diffusion layer unit. The electrode unit acts as an anode or a cathode.

Conventional methods known to those skilled in the art can be used to bind the catalyst layer unit and the diffusion layer unit. However, a hot pressing method is preferred.

In an embodiment, the hot pressing method can be performed at a temperature of 30 to 200° C., preferably 40-90° C., and a pressure of 0.1-1.0 ton/cm² for 1 to 20 minutes. If the temperature for the hot pressing is lower than 30° C., the catalyst layer unit and the diffusion layer unit cannot be strongly bound and may be separated from one another. If the temperature for the hot pressing is higher than 200° C., the catalyst may deteriorate.

The electrode unit is manufactured through the above-described processes. When an electrode unit is manufactured using a catalyst layer unit containing a catalyst for the cathode, the resulting electrode unit is referred to as a cathode unit. When an electrode unit is manufactured using a catalyst layer unit containing a catalyst for the anode, the resulting electrode unit is referred to as an anode unit.

The film attached to the catalyst layer unit can be removed anytime after the catalyst layer unit is dried and before the catalyst layer unit is bound with an electrolyte membrane. It is preferable that the film attached to the catalyst layer of the anode or cathode unit is removed after the anode or cathode unit is bound with the diffusion layer unit. If the film is attached from the electrode unit in another operation, processing becomes complicated and the efficiency decreases.

Bonding of Electrolyte Membrane and Electrode Unit

Next, an MEA is completed by bonding the electrode units (anode unit and cathode unit) and an electrolyte membrane.

The electrolyte membrane is located between the two electrode units, and one side of the electrolyte membrane is bound with the cathode unit, and the other side is bound with the anode unit. Conventional methods known to those skilled in the art can be used for the bonding process. However, a hot pressing method is preferred.

The hot pressing method can be performed at a temperature of 50 to 200° C., preferably 100 to 150° C. and a pressure of 0.1 to 1.0 ton/cm² for 1 to 20 minutes. If the temperature for the hot pressing is less than 50° C., the bonding is not sufficient and the interfacial resistance between the electrode and the electrolyte membrane increases, and in the worst case, the catalyst layer unit and the diffusion layer unit may be separated. If the temperature for the hot pressing is higher than 200° C., the electrolyte membrane may deteriorate due to dehydration.

The film attached to the diffusion layer unit can be removed anytime after the diffusion layer unit is sintered. However, it is preferable that the film attached to the diffusion unit is removed after the hot pressing, resulting in a complete MEA. If the film attached to the diffusion layer is removed in another operation, processing becomes complicated and the efficiency decreases.

The MEA is completed through the above-described processes.

Since the MEA manufactured above has no separate carbon substrate, the MEA is thin and can be used to form slim, compact fuel cells. In addition, the MEA also ensures a quick response and stable electric generation and lowers electrical resistance, thereby enabling a high performance fuel cell to be manufactured.

Hereinafter, a fuel cell including the MEA according to an aspect of the present invention will be described.

A fuel cell can be manufactured using the MEA according to an aspect of the present invention and conventional methods known to those skilled in the art. In other words, any fuel cell including the MEA according to an aspect of the present invention and bipolar plates located on both sides of the MEA lies within the scope of the present invention.

Hereinafter, an aspect of the present invention will be described in greater detail with reference to the following examples and comparative example. The following examples are for illustrative purposes and are not intended to limit the scope of the invention.

### EXAMPLE 1

Manufacturing of Catalyst Layer Unit

PtRu black and Pt black were respectively used as anode and cathode catalysts. Each of the metal catalysts, water, Nafion, and isopropylalcohol was mixed together in a weight ratio of 1:1:0.15:2 in a sonic bath for 2 hours to form catalyst layer slurries.

The catalyst layer slurries were respectively coated on PET films using screen printing and dried at 70° C. for 2 hours.

Manufacturing of Diffusion Layer Unit

Carbon black powder, polyvinylidenefluoride (PVdF), and isopropylalcohol were mixed in a weight ratio of 0.7:0.3:10 in a sonic bath for 2 hours to prepare a diffusion layer slurry.

The prepared diffusion layer slurry was coated on a PET film using screen printing and sintered at 170° C. for 1 hour to form a diffusion layer unit.

The diffusion layer unit was patterned using a cutting plotter to form circular openings (See FIG. 3B). The total area of the openings was 15% of the area of the diffusion layer unit.

Manufacturing of Electrode Unit

Each of the catalyst layer units and the diffusion layer unit were bounded by hot pressing at a temperature of 80° C. and a pressure of 0.7 ton/cm² for 5 minutes. Then, the film of each of the catalyst layer units was removed, thereby resulting in an anode unit and a cathode unit.

Manufacturing of MEA and Unit Cell

An electrolyte membrane was located between the anode unit and the cathode unit and bound together using hot pressing at a temperature of 120° C. and a pressure of 0.7 ton/cm² for 7 minutes to form an MEA. Nafion 115 membrane (available from DUPONT) was used as the electrolyte membrane.

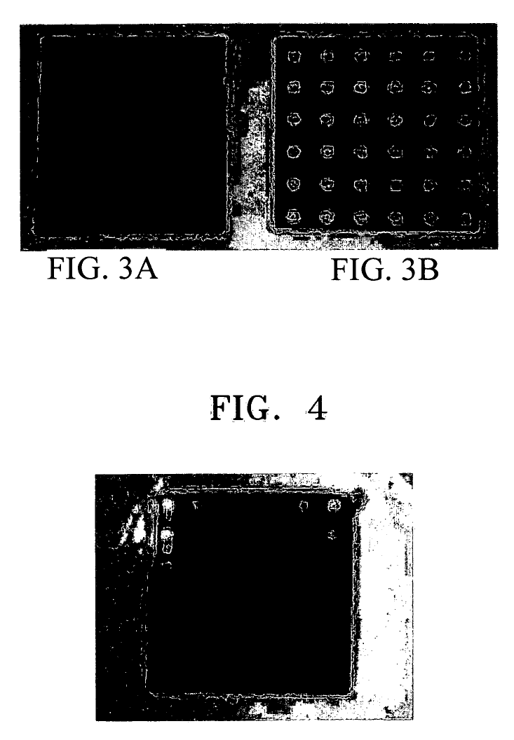

A unit cell was manufactured using the manufactured MEA (see FIG. 4) according to a conventional method known to those skilled in the art.

### COMPARATIVE EXAMPLE 1

Catalyst layer slurries were prepared in the same manner as in Example 1. The catalyst layer slurries were respectively coated on PET films using screen printing and dried at 70° C. for 2 hours in the same manner as in Example 1.

The resulting catalyst layers were bound on both sides of an electrolyte membrane using hot pressing at a temperature of 120° C. and a pressure of 0.7 ton/cm² for 7 minutes. The same electrolyte membrane as used in Example 1 was used.

A diffusion layer slurry was prepared in the same manner as in Example 1. The diffusion layer slurry was coated on carbon papers using a spraying method and sintered at 170° C. for 1 hour.

The catalyst layer-electrolyte membrane assembly was located between the diffusion layer-coated carbon papers and bound together using hot pressing at a temperature of 100° C. and a pressure of 0.7 ton/cm² for 7 minutes to form an MEA.

A unit fuel cell was manufactured using the MEA according to a conventional method known to those skilled in the art.

The unit cells manufactured in Example 1 according to an aspect of the present invention and Comparative Example 1 were tested as follows.

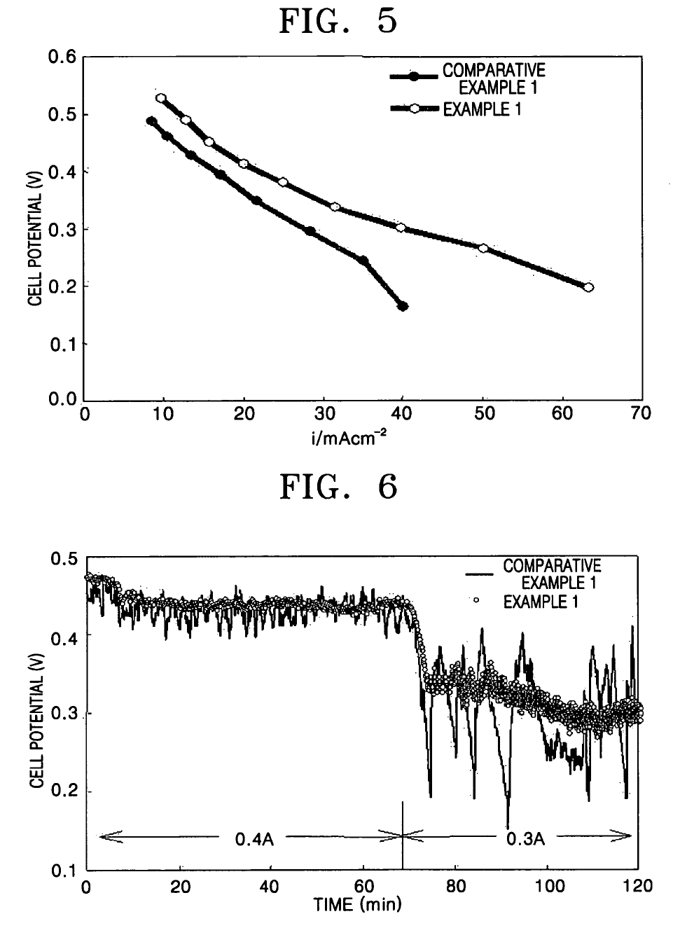

The currents in each of the unit cells with respect to cell potential were measured under the same conditions. The results are shown in FIG. 5. The measurements were conducted at 40° C. while supplying twice the methanol and air of the stoichiometrical composition.

Referring to FIG. 5, the unit cell according to Example 1 produced a larger amount of current than the unit cell according to Comparative Example 1 at an equal cell potential. This indicates that the fuel cell according to an aspect of the present invention has lower diffusion resistance and electric resistances and can produce a larger amount of effective electricity.

In addition, a stability test was carried out on the unit cells. First, the stability in cell potential was measured at a constant load while supplying a predetermined amount of methanol. Three times the stoichiometrically required methanol to generate a 0.4A current and twice the stoichiometrically required air to generate a 0.4A current were supplied. Referring to FIG. 6, the cell potential of the fuel cell according to Example 1 was much more stable than the fuel cell of Comparative Example 1.

Next, the stability in electromotive force was measured while varying the target current level. In other words, twice the stoichiometrically required methanol to generate a 0.3A current and twice the stoichiometrically required air to generate a 0.3A current were supplied. Referring to FIG. 6, the cell potential of the fuel cell according to Comparative Example seriously fluctuated, while the cell potential of the fuel cell according to Example was very stable.

The above results indicate that the fuel cell according to an aspect of the present invention is stable in mass transfer.

As described above, an MEA according to an aspect of the present invention is thin and can be used to manufacture a slim, compact fuel cell. The MEA also ensures a quick response and stable electric generation and lowers electrical resistance, thereby enabling a high performance fuel cell to be manufactured. In addition, since no separate carbon substrate is required, the manufacturing costs of the MEA are reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A membrane electrode assembly comprising:
a cathode including a catalyst layer and a first diffusion layer, the first diffusion layer having openings;
an anode including a catalyst layer and a second diffusion layer, the second diffusion layer having openings; and
an electrolyte membrane interposed between the cathode and the anode.

2. The membrane electrode assembly of claim 1, wherein an aspect ratio of the openings of each of the first and second diffusion layers is in a range of 1-3.

3. The membrane electrode assembly of claim 1, wherein a total area of the openings of each of the first and second diffusion layers is in a range of 5-85%.

4. The membrane electrode assembly of claim 3, wherein the total area of the openings of each of the first and second diffusion layers is in a range of 30-65%.

5. The membrane electrode assembly of claim 1, wherein the anode further includes a hydration layer.

6. The membrane electrode assembly of claim 5, wherein the hydration layer contains SiO₂, TiO₂, phosphotungstic acid, phosphomolybdenum acid, or a combination of the forgoing materials.

7. A method of manufacturing a membrane electrode assembly, the method comprising:
forming catalyst layers on films and drying the catalyst layers to form catalyst layer units;
forming diffusion layers on films and sintering the diffusion layers to form diffusion layer units;
forming openings in each of the diffusion layer units;
respectively bonding the catalyst layer units and the diffusion layer units such that the catalyst layer on each of the catalyst layer units contacts a diffusion layer of the corresponding diffusion layer unit to form electrode units;
bonding the electrode units to both sides of a polymer electrolyte membrane;
removing the film from each of the catalyst layer units after either forming the catalyst layer units, forming the diffusion layer units, forming the openings in each of the diffusion layer units, or forming the electrode units; and
removing the film from each of the diffusion layer units after either forming the catalyst layer units, forming the diffusion layer units, forming the openings in each of the diffusion layer units, forming the electrode units or bonding the electrode units to both sides of the polymer electrolyte membrane.

8. The method of claim 7, wherein, in forming the catalyst layer units, the catalyst layers are dried at a temperature of 60-120° C. for 1-4 hours.

9. The method of claim 7, wherein, in forming the diffusion layer units, the diffusion layers are sintered at a temperature of 150-350° C. for 30 minutes to 2 hours.

10. The method of claim 7, wherein, in forming the electrode units, the bonding is performed using hot pressing.

11. The method of claim 10, wherein the hot pressing is performed at a temperature of 30-200° C.

12. The method of claim 7, wherein, in bonding the electrode units to both sides of the polymer electrolyte membrane, the bonding is performed using hot pressing.

13. The method of claim 12, wherein the hot pressing is performed at a temperature of 50-200° C.

14. The method of claim 7, wherein the mass per unit area of each of the catalyst layer units in forming the catalyst layer units is in a range of 2-8 mg/cm².

15. The method of claim 7, wherein the mass per unit area of each of the diffusion layer units in forming the diffusion layer units is in a range of 0.1-4 mg/cm².

16. The method of claim 7, wherein an aspect ratio of the openings in the diffusion layer units is in a range of 1-3.

17. The method of claim 7, wherein a total area of the openings in each of the diffusion layer units is in a range of 5-85% of an area of the diffusion layer unit.

18. The method of claim 7, further comprising respectively forming hydration layers between the films and the diffusion layers in forming the diffusion layer units.

19. The method of claim 18, wherein a hydration layer is formed only between the film of the diffusion layer unit to be used in an anode and the diffusion layer.

20. The method of claim 7, wherein the diffusion layers include a mixture of a carbon powder, a binder and a diffusion medium.

21. The method of claim 20, wherein the composition ratio of the carbon powder, the binder and the diffusion medium ranges from 0.9:0.1:10 to 0.5:0.5:10.

22. The method of claim 18, wherein a thickness of each of the hydration layers is in a range of 0.01-1 μm.

23. The method of claim 10, wherein the hot pressing is performed at a pressure of 0.1-10. ton/cm² for 1 to 20 minutes.

24. The method of claim 12, wherein the hot pressing is performed at a pressure of 0.1-10. ton/cm² for 1 to 20 minutes.

25. A fuel cell comprising a membrane electrode assembly, the membrane electrode assembly comprising:
a cathode including a catalyst layer and a diffusion layer having openings;
an anode including a catalyst layer and a diffusion layer having openings; and
an electrolyte membrane interposed between the cathode and the anode.

26. A membrane electrode assembly comprising:
a cathode including a catalyst layer and a first diffusion layer, the first diffusion layer having openings;
an anode including a catalyst layer and a second diffusion layer, the second diffusion layer having openings; and
an electrolyte membrane interposed between the cathode and the anode,
wherein the membrane electrode assembly does not include a separate carbon substrate.
